(19) United States
(12) Patent Application Publication
(10) Pub. No.: US 2015/0108927 A1
(43) Pub. Date: Apr. 23, 2015

(54) Method and Device for the Electrodynamic Braking of a Universal Motor

(71) Applicant: Robert Bosch GmbH, Stuttgart (DE)

(72) Inventors: Jacek Wiszniewski, Leinfelden-Echterdingen (DE); Kamil Pogorzelski, Stuttgart (DE)

(73) Assignee: Robert Bosch GmbH, Stuttgart (DE)

(21) Appl. No.: 14/391,842

(22) PCT Filed: Mar. 5, 2013
(86) PCT No.: PCT/EP2013/054424

§ 371 Date: Oct. 10, 2014

(30) Foreign Application Priority Data
Apr. 11, 2012 (DE) 10 2012 205 876.1

(51) Int. Cl. H02P 3/18; H02P 25/14

(52) U.S. Cl. CPC H02P 3/18; H02P 25/14
USPC 318/245

(57) ABSTRACT

A method and device for the electrodynamic braking of a universal motor. The method comprises continuously ascertaining a rotational speed of the universal motor, temporarily, periodically short-circuiting an armature of the universal motor with a semiconductor switch to brake the universal motor, and setting firing angles of the semiconductor switch according to an indexed mapping of firing angles to target rotational speeds of the universal motor. Each of the set firing angles is adapted to an ascertained rotational speed value.

The present invention relates to a method and a device for the electrodynamic braking of a universal motor.

### BACKGROUND INFORMATION

A method for the electrodynamic braking of a universal motor is, for example, known from WO 2011/076827. The method disclosed there disadvantageously does not adapt to changes of the rotational speed due to external influences or due to changes of a target rotational speed during the braking operation. This may result in serious malfunctions, for example, an undesirable restart of the universal motor and/or increased brush sparking and thus wear to the armature of the universal motor may result.

### SUMMARY OF THE INVENTION

The object of the present invention is therefore to provide an improved method for the electrodynamic braking of a universal motor.

This object is achieved according to a first aspect by a method for the electrodynamic braking of a universal motor, having the following steps during a braking operation:
Continuously ascertaining a rotational speed of the universal motor;
Temporarily, periodically short-circuiting an armature of the universal motor by means of a semiconductor switch, wherein firing angles of the semiconductor switch are set according to an indexed mapping of firing angles to target rotational speeds of the universal motor, wherein each of the set firing angles is essentially adapted to the ascertained rotational speed value.

One advantage of the method according to the present invention is that by adapting the firing angle to the actual rotational speed, a braking operation of the universal motor may be significantly shortened. By taking into account an actual rotational speed profile according to the present invention during the entire braking operation, a rapid adaptation of the firing behavior of the second semiconductor switch may be achieved.

As a result, wear of the commutator may be significantly reduced. Furthermore, individual operating conditions of the universal motor may advantageously be taken into account during the braking operation. Furthermore, as a result, a predefined mapping of target rotational speeds to firing angles may advantageously be easily adapted, whereby an adaptation of braking profiles to ideal braking profiles may be carried out in a convenient manner.

One refinement of the method provides that in the case that the ascertained rotational speed deviates from the target rotational speed by a defined amount, a firing angle in the mapping is accessed across indices. As a result, large rotational speed changes of the universal motor during the braking operation which are mostly caused externally may advantageously also be taken into account via correspondingly large changes of the firing angle of the second semiconductor switch.

Preferred refinements of the method provide that the mapping is designed as a table or a straight-line approximation. As a result, the mapping may be advantageously implemented in various technical ways.

One preferred refinement of the method provides that the mapping takes into account a maximum loading of the universal motor. In this way, an extreme loading of the universal motor may be taken into account, whereby loadings of the universal motor which are lower than the maximum loading are able to be handled in a safe manner. A safety level for the universal motor is thus advantageously increased.

One preferred refinement of the method provides that the maximum loading has a maximum target rotational speed and a maximum moment of inertia for the universal motor. As a result, the loading of the universal motor may be exhausted to the greatest possible extent in terms of a worst-case scenario.

One preferred refinement of the method provides that the firing angle of the second semiconductor switch is also adapted to the ascertained rotational speed by means of a regulating device. The resulting advantage is that a change of the firing angle may also be carried out according to the regulator principle.

According to another aspect of the present invention, the object is achieved using a device for the electrodynamic braking of an electric motor, having:
a rotational speed sensor for continuously ascertaining a rotational speed of the universal motor;
a semiconductor switch with which an armature of the universal motor is temporarily, periodically short-circuited for the braking of the universal motor, wherein firing angles of the semiconductor switch are set according to an indexed mapping of firing angles to target rotational speeds of the universal motor situated in a control device, wherein each of the set firing angles is essentially adapted to the ascertained rotational speed value.

The present invention is described in greater detail below having additional features and advantages, based on multiple figures. In this context, all described or illustrated features, individually or in any combination, constitute the subject matter of the present invention, regardless of their recapitulation in the patent claims or their back-reference, and regardless of their wording and representation in the description and in the figures. The figures are primarily intended to illustrate the principles relevant to the present invention.

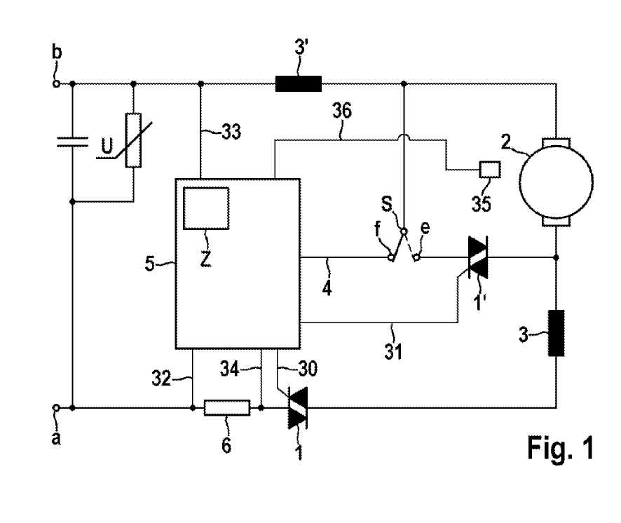

FIG. 1 shows a schematic representation of an electrodynamic braking device for a universal motor with which the method according to the present invention may be carried out;

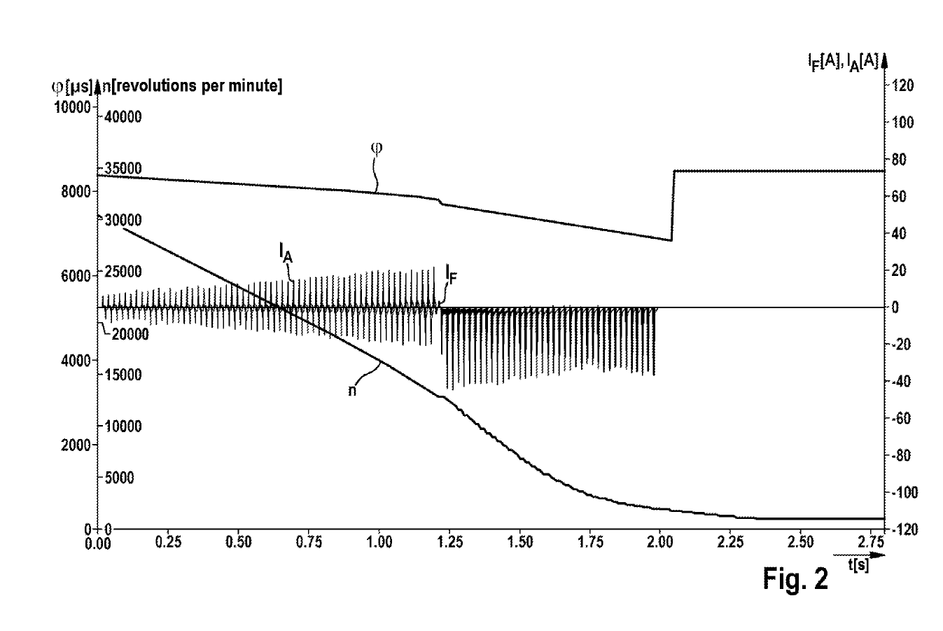

FIG. 2 shows a schematic time profile of characteristic values of a universal motor during a conventional electrodynamic braking operation; and

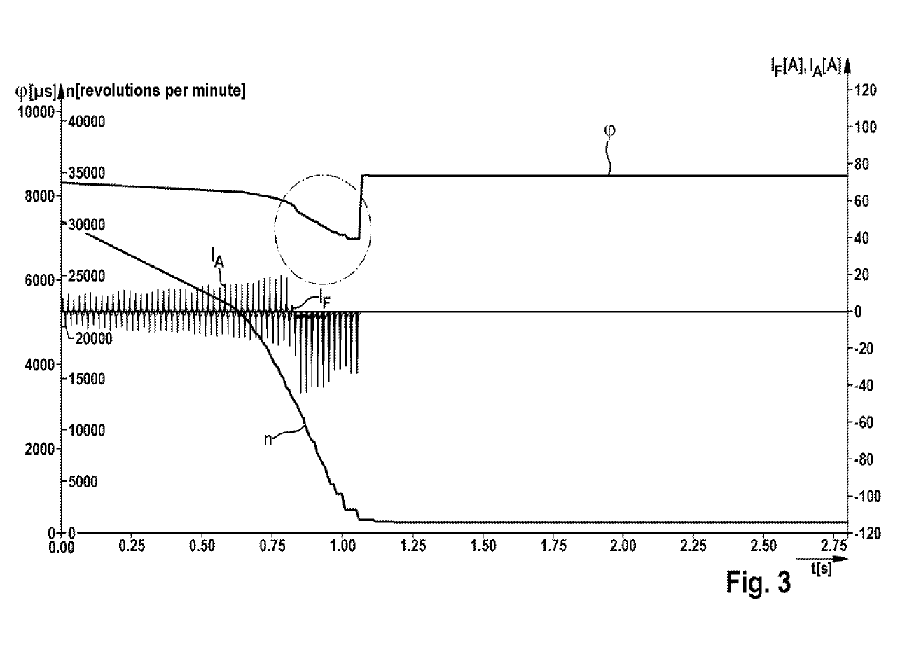

FIG. 3 shows a schematic time profile of characteristic values of a universal motor during an electrodynamic braking operation according to the present invention.

FIG. 1 shows a schematic circuit diagram of an electrodynamic braking device for an electric universal motor. The device essentially corresponds to a system disclosed in WO 2011/076827. The electrodynamic braking device has an indexed mapping Z within an electronic control device 5 which, for example, may be designed as a microcontroller circuit. The mapping Z comprises multiple combinations of firing angles φ of the second electronic semiconductor switch 1′, each having corresponding rotational speeds of the universal motor from a previously ascertained, ideal braking operation of the universal motor. A rotational speed sensor 35 is provided for a continuous ascertainment of the rotational speed n of the universal motor during the braking operation. Reference will not be made below to additional circuit and function details of the system shown in FIG. 1, as they are already known from WO 2011/076827.

FIG. 2 shows a schematic time diagram having characteristic values of a universal motor during a conventional electrodynamic braking operation which, for example, is carried out via the electrodynamic braking device from FIG. 1. During the braking operation of the universal motor, the first semiconductor switch 1 is fired in a phase-angle control in each half cycle of the power grid voltage, and the second semiconductor switch 1′ is fired after a brief delay. In a phase-angle operation, a firing angle φ of the second semiconductor switch 1′ is changed according to a predefined firing angle profile stored in a mapping Z. The condition for the firing of the second semiconductor switch 1′ is in each case that the first semiconductor switch 1 was previously fired or switched through.

It is apparent that a rotational speed n of the universal motor drops from approximately 30,000 revolutions per minute to approximately 1,000 revolutions per minute during the braking operation. A time profile of the armature current I_{A} and a profile of the field current I_{F} represent power drains of the universal motor during the braking operation, wherein a braking effect on the universal motor is essentially generated by the armature current I_{A}. At approximately 1.15 s, a so-called “half-cycle operation” begins due to the already steep drop in rotational speed, in which the second semiconductor switch 1′ is fired only in every second half cycle of the power grid voltage.

A great disadvantage of the conventional braking operation of the universal motor depicted in FIG. 2 is that the firing angle φ of the second semiconductor switch 1′ is always set in an unchangeable manner according to the predefined ideal firing angle profile. This is also the case if abrupt drops occur in the rotational speed profile, for example, due to an external mechanical effect on a tool of the universal motor. Increased brush sparking and thus increased wear of the commutator of the universal motor may disadvantageously result, whereby an operational lifetime of the universal motor may be considerably shortened. Furthermore, no individual operating conditions of the universal motor, such as changing viscosities of lubricants used, production tolerances, loading due to tools, temperatures, etc., all of which may affect an operating behavior of the universal motor, may be taken into account by means of the fixed firing angle profile.

According to the present invention, to eliminate the aforementioned disadvantages, it is provided that during the braking operation of the universal motor, a rotational speed n is continuously ascertained by means of the rotational speed sensor 35 and is compared to an indexed ideal target rotational speed of the braking operation of the universal motor stored in the mapping Z. The aforementioned indexed mapping Z may, for example, be designed as a table or as a straight-line approximation of at least two straight lines. It goes without saying that the aforementioned mapping Z may be designed in any known manner.

In the event that a deviation of the ascertained rotational speed n from the target rotational speed expected at the respective point in time is detected during the aforementioned comparison of the rotational speeds, an adjustment of the firing angle φ of the second electronic semiconductor switch 1′ is carried out according to the method according to the present invention. In this way, the firing angle φ of the second electronic semiconductor switch 1′ is always optimally adapted to the actual rotational speed n. In addition, in the event of large reductions in rotational speed, it may be required in some circumstances to carry out jumps across multiple indices within the indexed mapping Z in order to access the suitable firing angle φ for firing and using the second semiconductor switch 1′.

According to the present invention, in the indexed mapping Z, which corresponds to an ideal braking profile defined by means of firing angle values and rotational speed values, it is thus sought to set the firing angle φ which is characterized in that it is mapped to the target rotational speed in the indexed mapping Z which essentially corresponds to the ascertained rotational speed n.

In defining the ideal braking profile, a balance is sought to the effect that on the one hand, the braking time is kept as short as possible, but on the other hand, the current across the armature 2 is also kept as low as possible in order to minimize wear. In the case that the rotational speed ascertained during the braking operation of the universal motor essentially corresponds to the target rotational speed, a sequential processing of the firing angle φ within the mapping Z is carried out as in the manner already known.

One profile according to the present invention of the characteristic values firing angle, rotational speed, armature current, and field current is schematically depicted in FIG. 3. In the time profile of FIG. 3, the aforementioned, externally induced abrupt reduction of the rotational speed n is apparent at between approximately 0.5 s and approximately 1 s of the braking operation. The striking drop in rotational speed may, for example, be caused by a massive external application of force to the universal motor, for example, to a tool driven by the universal motor.

In response, a jump is carried out within the mapping within the indexed mapping Z of firing angles or current flow angles φ to rotational speeds n in such a way that the firing angle φ of the second electronic semiconductor switch 1′ is selected in such a way that the resulting rotational speed of the universal motor essentially corresponds to the actual ascertained rotational speed n. This is indicated in FIG. 3 by graphical highlighting in the firing angle profile. The current rotational speed n is ascertained in each half cycle of the power grid voltage by means of the rotational speed sensor 35 and compared to the ideal target rotational speed stored in the mapping Z during the braking operation.

In comparison to the setting of the firing angles φ of the time profile of FIG. 2, the firing angle φ thus changes its time profile according to the present invention in order thereby to be adapted to the current rotational speed n of the universal motor in a flexible manner.

As a result, it is advantageously possible to significantly shorten the braking operation and to reduce the current flow due to electromagnetic induction processes within the armature 2. This may advantageously significantly reduce a disadvantageous effect on the commutator.

As an additional improvement of the electrodynamic braking operation, it is preferably also possible that a regulating device (not shown) is situated within the electronic control device 5, which readjusts the firing angle φ of the second semiconductor switch 1′ in the event of smaller deviations of the ascertained rotational speed from the target rotational speed. The aforementioned regulation naturally has a certain limited regulation reserve and therefore cannot process excessively large rotational speed changes, such as by means of the previously described jumps within the indexed mapping Z. In the event of a deviation from the ideal rotational speed, a firing angle corresponding to the rotational speed difference is either added to or subtracted from the currently set firing angle.

The aforementioned mapping Z preferably takes into account a maximum loading of the universal motor in a worst-case scenario. For this purpose, in a determination process of the mapping Z, for example, the universal motor is equipped with a heavy tool (for example, a circular saw having a maximum diameter or a hammer having a chisel which is as large as possible) and brought to a maximum rotational speed. An ideal braking operation of the universal motor is then ascertained, wherein the braking operation should preferably not be influenced by external influences. The value combinations for the firing angles φ and the target rotational speeds thus ascertained are stored in a suitable form in the mapping Z. In this way, even if loading of the universal motor is lower than the maximum loading, it is supported that the desired braking profile may also be achieved to the greatest possible extent.

The aforementioned mapping Z and the regulating device are preferably stored within the control device 5 as a computer program. It is also possible to implement the mapping Z alternatively in known ways. In this way, only a low expenditure of additional computer power or of semiconductor memory results for the method according to the present invention. Advantageously, no additional hardware expenditure is required for the method according to the present invention. Furthermore, the method according to the present invention may also be stored on computer-readable data carriers and thus implemented or carried out on different control devices 5 in a simple manner.

In summary, the present invention proposes an improved electrodynamic method for the braking of a universal motor, in which a firing angle profile of a semiconductor switch is set during the braking operation according to the actual, current rotational speed. As a result, a significant shortening of the braking time and a significant reduction of brush sparking at the armature may advantageously result, which may advantageously mean lower wear and thus an extended lifetime of the universal motor.

In principle, it is advantageously also possible that the method according to the present invention is applicable to rotational speed increases during the braking operation.

Although the present invention has been described based on a universal motor, it goes without saying that the present invention may be used for any types of common electric motors having armatures/rotors, which have a rotational speed detection and an electronic brake.

Furthermore, it goes without saying that the schematic system depicted FIG. 1 for carrying out the method according to the present invention is only exemplary. Instead of the triacs which are depicted, thyristors, MOSFETs, IGBTs, or other power semiconductor switches may also be used in a suitable number in each case as first and second electronic semiconductor switches 1, 1′.

Those skilled in the art will thus modify and/or combine the features of the present invention in a suitable manner without deviating from the core of the present invention.

1. A method for electrodynamic braking of a universal motor, comprising:
continuously ascertaining a rotational speed of the universal motor;
temporarily, periodically short-circuiting an armature of the universal motor with a semiconductor switch to brake the universal motor; and
setting firing angles of the semiconductor switch according to an indexed mapping of firing angles to target rotational speeds of the universal motor,
wherein each of the set firing angles is adapted to an ascertained rotational speed value.

2. The method as claimed in claim 1, wherein the mapping is configured as a table.

3. The method as claimed in claim 1, wherein the mapping is configured as a straight-line approximation.

4. The method as claimed in claim 2, further comprising:
accessing the firing angle in the mapping across indices when an ascertained rotational speed deviates from a target rotational speed by a defined amount.

5. The method as claimed in claim 1, wherein the mapping is based at least in part on a maximum loading of the universal motor.

6. The method as claimed in claim 5, wherein the maximum loading has a maximum target rotational speed and a maximum moment of inertia for the universal motor.

7. The method as claimed in claim 1, wherein the firing angle of the semiconductor switch is adapted to the ascertained rotational speed by a regulating device.

8. A device for electrodynamic braking of a universal motor, comprising:
a rotational speed sensor configured to continuously ascertain a rotational speed of the universal motor;
a semiconductor switch configured to temporarily, periodically short-circuit an armature of the universal motor to brake the universal motor; and
a control device configured to set firing angles of the semiconductor switch according to an indexed mapping of firing angles to target rotational speeds of the universal motor, wherein each firing angles set is adapted to the rotational speed value ascertained.

9. (canceled)
